(19) United States
(12) Patent Application Publication
(10) Pub. No.: US 2007/0063632 A1
(43) Pub. Date: Mar. 22, 2007

(54) FLUORESCENT TUBE HOLDING DEVICE

(76) Inventors: Ching-Chung Chang, Taipei City (TW); Yung-Chen Wu, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/420,810

(22) Filed: May 30, 2006

(30) Foreign Application Priority Data
Sep. 22, 2005 (TW) 094132900

(51) Int. Cl. H01J 1/62; H01J 63/04

(52) U.S. Cl. 313/493

(57) ABSTRACT

A fluorescent tube holding device has a heater that warms up the fluorescent tube when the fluorescent tube is in a standby space of the fluorescent tube holding device. The fluorescent tube holding device keeps the fluorescent tube at a certain temperature range that provides the fluorescent tube with a best working status.

### BACKGROUND OF THE INVENTION

1. Field of the Invention

The present invention relates to a holding device, and more specifically, to a fluorescent tube holding device.

2. Description of the Prior Art

Devices like fax machines, scanners, copiers, or multifunctional office machines integrated with the functions of printing, scanning, faxing, and copying, are becoming very common electronic products. To convert documents into usable digital images, these devices must have a scanning unit, which generally uses a cold cathode fluorescent lamp (CCFL) as a scanning light source. The CCFL emits light onto a document. The light reflected from the document is then received by a light sensor, and is converted into digital data.

Please refer to FIG. 1, which is an illustration of a relation between time and brightness when a CCFL is warming up according to the prior art, wherein the abscissa represents time and the ordinate represents brightness. The CCFL only emits enough charged particles as a steady light source when the temperature of the CCFL reaches a certain level. Generally, 45 to 90 seconds are required, also called the “warming time (t0˜t1)”, to warm the CCFL to the steady state. FIG. 1 shows that it is not appropriate for the CCFL to scan during the warming time, i.e., from the beginning (t0 in FIG. 1) to the time of steady brightness (t1 in FIG. 1) since the brightness of the CCFL varies greatly. The CCFL is steady and sufficient in brightness after the warming is finished, and it then can perform scanning.

The long time required to warm the CCFL limits the performance of the scanner. To shorten the warming time of the CCFL, the prior art uses a heating device to accelerate warming of the CCFL. A design from Taiwan patent 1225,269 entitled “CCFL Wrapped with A Heater Wire, and Machines for Manufacturing Same” to Anderson et al. discloses a CCFL heater that has nickel-chromium wire wrapped on a fluorescent tube to heat the fluorescent tube. This design shortens the warming time of the CCFL to 30 seconds at first use, and the nickel-chromium wire keeps the CCFL warm when in a standby status. The design can also put the CCFL into the best temperature status in 3 seconds. Other techniques of the prior art solve the problem of long warming time in a similar way. Unfortunately, the nickel-chromium wire wrapped on the tube can be easily broken during operation. Nickel-chromium wire is also a material with high cost. Besides, using the nickel-chromium wire wrapped around the tube may mask part of the light emitted by the tube, which lowers the efficiency and quality of the CCFL.

### SUMMARY OF THE INVENTION

The claimed invention provides a fluorescent tube holding device capable of keeping a fluorescent tube at a standby state. The holding device comprises a housing having a standby space for accommodating the fluorescent tube when at the standby state and a heater installed on a first side of the standby space for generating heat for warming up the fluorescent tube.

The claimed invention also provides a fluorescent tube holding device capable of keeping a fluorescent tube at a standby state. The holding device comprises a housing having a standby space for accommodating the fluorescent tube when at the standby state and a cooler installed on a first side of the standby space for warming up the fluorescent tube or cooling down the fluorescent tube.

The claimed invention also provides a scanner having a fluorescent tube holding device. The scanner comprises a housing; a fluorescent tube holding device fixed onto one side of the housing, the fluorescent tube holding device having a standby space for accommodating a fluorescent tube when at a standby state; and a heater installed on a first side of the standby space for generating heat for warming up the fluorescent tube.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a relation between time and brightness when a CCFL is warming up according to the prior art.

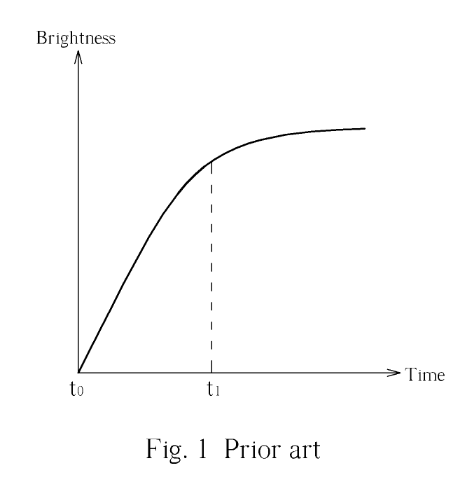

FIG. 2 is an illustration of a fluorescent tube holding device with the fluorescent tube in a standby state according to the present invention.

FIG. 3 is an illustration of a side view when the fluorescent tube is kept in a standby space in a standby state.

FIG. 4 is an illustration of an exemplary embodiment of the heater of the holding device in FIG. 2.

FIG. 5 is an illustration of a relation between working temperature and surface luminance of a fluorescent tube.

FIG. 6 is an illustration of another exemplary embodiment of the holding device according to the present invention.

### DETAILED DESCRIPTION

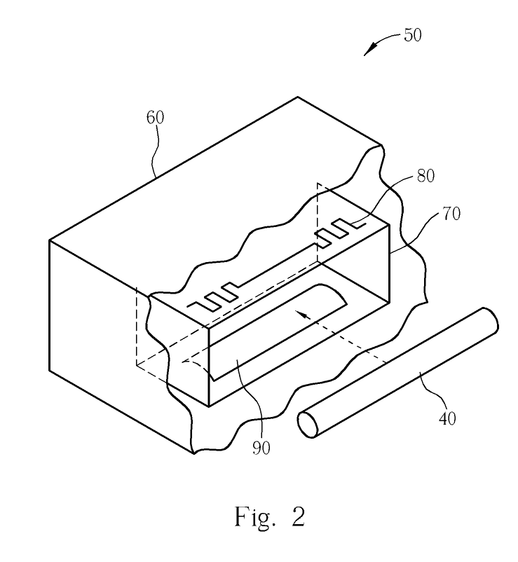

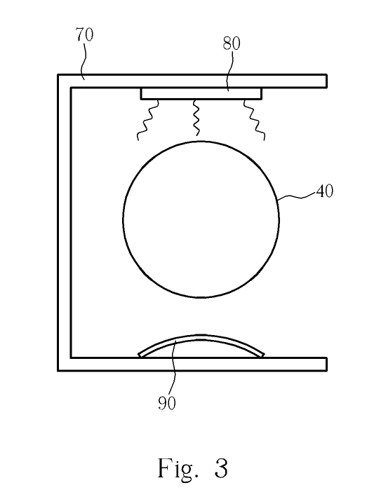

Please refer to FIG. 2 and FIG. 3. FIG. 2 is an illustration of a fluorescent tube 40 holding device 50 with a fluorescent tube 40 in a standby state according to the present invention. FIG. 3 is an illustration of a side view when the fluorescent tube 40 is kept in a standby space 70 in the standby state. The holding device 50 comprises a housing 60 having a standby space 70, a heater 80, and a reflector 90. The standby space 70 is for accommodating the fluorescent tube 40 when in the standby state. The heater 80 is installed on a first side of the standby space 70 for generating heat for warming up the fluorescent tube 40.

When a scanner with the holding device 50 is turned on and in the standby state, an electrode heats the fluorescent tube 40 to a best working temperature once the fluorescent tube 40 receives commands for emitting light. As FIG. 3 shows, the heater 80 generates heat and is treated as an external heat source to the fluorescent tube 40 since it is kept in the holding device 50. The heat radiated from the heater 80 encourages the rate of warming of the fluorescent tube 40 to the best temperature. Additionally, in an exemplary embodiment of the present invention, the holding device 50 operates not only when the fluorescent tube 40 receives commands for emitting light, but also operates to directly heat the fluorescent tube 40 when the scanner is turned on (or even turned off but electrically connected), allowing for the fluorescent tube 40 to have a shorter warming time to the best temperature once receiving scanning commands.

Full exploitation of heat radiated by the heater 80 can further promote the warming rate of the fluorescent tube 80. In an exemplary embodiment according to the present invention, the holding device 50 further comprises a reflector 90 installed on a second side of the standby space, where the second side is relative to the first side where the heater 80 is installed. In other words, the heater 80 and the reflector 90 are respectively installed on the opposite sides of the fluorescent tube 80. When heat generated by the heater 80 is radiated to the fluorescent tube 40, some heat is not absorbed by the fluorescent tube 40 and is dissipated. The dissipated heat can be reflected to the fluorescent tube 40 by the reflector 90, thus substantially increasing warming efficiency of the heater 80. In a preferred exemplary embodiment according to the present invention, the housing 60 is made of material with low heat transfer coefficient, and the material of the reflector 90 is highly heat reflective, and can be installed on surfaces inside the standby space 70 except for the area where the heater 80 is installed.

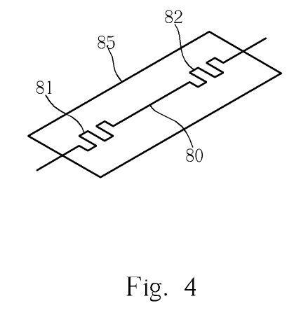

Please refer to FIG. 4, which is an illustration of an exemplary embodiment of the heater 80 of the holding device 50. The fluorescent tube 40 needs to be heated at the electrodes located at two ends of the fluorescent tube 40; therefore, the heater 80 has denser heating zones 81, 82 at the locations of the two ends of the fluorescent tube 80. Such design of the heater 80 generates more heat at the locations of the two electrodes, wastes less heat, and raises the heating efficiency. In the middle part of the heater 80 the wire goes straight. The heater 80 of the present invention can be a metallic wire, and more specifically, a defrost wire commonly used on car's back windscreen or a heater-on-glass (HOG) structure. A HOG is manufactured with firstly laying a thermo-isolated layer on a base plate 85, printing above a reflection layer made of silver glue, reserving threads of the heater 80 in the reflection layer, and lastly covering up a carbon membrane as the main part of the heater 80. However, the method of making the heater 80 should not limit the exemplary embodiment.

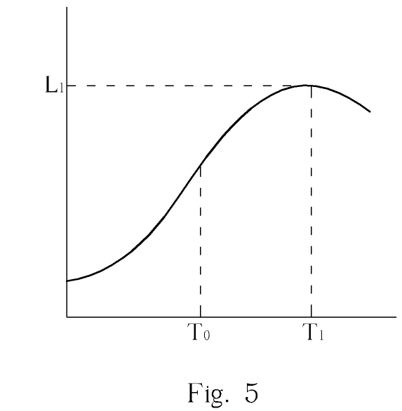

Please refer to FIG. 5, which is an illustration of a relation between working temperature and surface luminance of the fluorescent tube 40. As FIG. 4 shows, the fluorescent tube 40 has a maximum surface luminance when it is heated to a specific temperature T1. As a matter of fact, as FIG. 5 shows, the location of the specific temperature T1 corresponds to a maximum surface luminance, and the fluorescent tube 40 degrades in its surface luminance as the working temperature of the fluorescent tube 40 increases higher than the temperature T1. Therefore, the fluorescent tube 40 has a best luminous efficiency if it is kept at a certain temperature range about the specific temperature T1 when the scanner is working (Generally T1 is 50° C. and is product dependent.). Another exemplary embodiment of the present invention accomplishes fast heating of the fluorescent tube 40 and also temperature controlling via a Petier-like refrigerator.

Additionally, when the holding device 50 of the present invention is applied to an optical device such as a scanner, the holding device 50 is fixed onto one side of the scanner. The fluorescent tube 40 is moveably installed in the scanner. The holding device 50 has a standby space 70 for accommodating the fluorescent tube 40 when the fluorescent tube returns from a working space of the scanner. The heater 80 that heats the fluorescent tube 40 is installed on one side of the standby space 70 and does not move with the fluorescent tube 40. When the fluorescent tube 40 stays in the standby space 70, the heater 80 heats the fluorescent tube 40 to and maintains it at a proper working temperature.

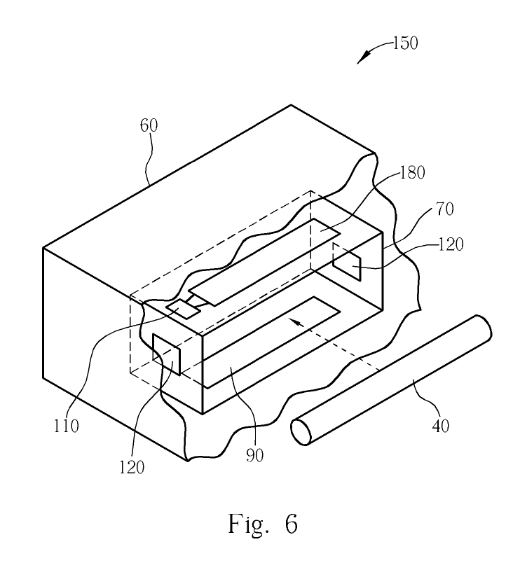

Please refer to FIG. 6, which is an illustration of another exemplary embodiment of the holding device 150 according to the present invention. Different from the previous exemplary embodiment, the holding device 150 replaces the heater 80 of the holding device 50 with a Petier-like refrigerator 180, and at least one thermal resistor 120 is installed in the standby space 70 of the holding device 150. The way that the holding device 150 heats the fluorescent tube 40 is the same as in the previous exemplary embodiment, and the layout of the Petier-like refrigerator 180 is similar to that of the heater 80, both having larger areas to heat the electrodes at the ends of the fluorescent tube 40 to reduce heating time.

As described above, the fluorescent tube 40 has maximum luminous efficiency when it is at a specific temperature T1. The thermal resistor 120 installed in the standby space 70 of the holding device 150 functions to detect the temperature of the fluorescent tube 40, and to send a sensing signal when the temperature of the fluorescent tube 40 goes over a level from the specific temperature T1. A switch 110 coupled with the Petier-like refrigerator 180 then switches the polarity of the Petier-like refrigerator 180 when receiving the sensing signal. When the polarity of the Petier-like refrigerator 180 changes, the hot side of the Petier-like refrigerator 180 that heats the fluorescent tube 40 is switched to serve the cold side of the Petier-like refrigerator 180, and it cools down the fluorescent tube 40. On the other hand, when the thermal resistor 120 detects a temperature of the fluorescent tube 40 in the standby space 70 lower than a level from the specific temperature T1, the switch 110 switches the polarity of the Petier-like refrigerator 180 and the Petier-like refrigerator 180 heats the fluorescent tube 40 again. In such way, the temperature of the fluorescent tube 40 can be kept within a range according to a working temperature. The polarity of the Petier-like refrigerator 180 is dynamically switched for an optimal temperature control when the temperature of the fluorescent tube 40 lies outside a range about a specific temperature, say, T1±t° C.

The fluorescent tube holding device of the present invention has a heater that warms up the fluorescent tube when the fluorescent tube is in a standby space of the fluorescent tube holding device. The fluorescent tube holding device keeps the fluorescent tube at a certain temperature range that provides the fluorescent tube with a best working status.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fluorescent tube holding device capable of keeping a fluorescent tube at a standby state, comprising:
a housing having a standby space for accommodating the fluorescent tube when at the standby state; and
a heater installed on a first side of the standby space for generating heat for warming up the fluorescent tube.

2. The holding device of claim 1 further comprising a reflector installed on a second side of the standby space for reflecting heat generated by the heater onto the fluorescent tube.

3. The holding device of claim 1 wherein the heater is a metallic wire.

4. The holding device of claim 1 wherein the heater has denser parts of metallic wire at two ends near two electrodes of the fluorescent tube.

5. A fluorescent tube holding device capable of keeping a fluorescent tube at a standby state, comprising:
a housing having a standby space for accommodating the fluorescent tube when at the standby state; and
a cooler installed on a first side of the standby space for warming up the fluorescent tube or cooling down the fluorescent tube.

6. The holding device of claim 5 further comprising a reflector installed on a second side of the standby space for reflecting heat generated by the cooler onto the fluorescent tube.

7. The holding device of claim 5 further comprising a thermal resistor installed in the standby space for detecting a temperature of the fluorescent tube.

8. The holding device of claim 5 further comprising a switch electrically connected to the cooler for switching a polarity of the cooler.

9. A scanner having a fluorescent tube holding device, comprising:
a housing;
a fluorescent tube holding device fixed onto one side of the housing, the fluorescent tube holding device having a standby space for accommodating a fluorescent tube when at a standby state; and
a heater installed on a first side of the standby space for generating heat for warming up the fluorescent tube.

10. The scanner of claim 9 further comprising a reflector installed on a second side of the standby space for reflecting heat generated by the heater onto the fluorescent tube.

11. The scanner of claim 9 wherein the heater is a metallic wire.

12. The scanner of claim 9 wherein the heater has denser parts of metallic wire at two ends near two electrodes of the fluorescent tube.
